(19) United States
(12) Patent Application Publication
(10) Pub. No.: US 2025/0294485 A1
(43) Pub. Date: Sep. 18, 2025

(54) MODEM CLOCK FREQUENCY ADAPTATION

(71) Applicant: QUALCOMM Incorporated, San Diego, CA (US)

(72) Inventors: Ahmed ZAKI, Bengaluru (IN); Kapil BHATTAD, Bangalore (IN); Shashidhar VUMMINTALA, Bangalore (IN); Supratik BHATTACHARJEE, San Diego, CA (US); Vinod RAMASWAMY, Hyderabad (IN); Arvind SRIDHARAN, Bangalore (IN)

(21) Appl. No.: 18/606,954

(22) Filed: Mar. 15, 2024

(51) Int. Cl. H04W 56/00; H04L 1/08

(52) U.S. Cl. CPC H04W 56/004; H04L 1/08

(57) ABSTRACT

Certain aspects of the present disclosure provide techniques for wireless communications by an apparatus. A method includes receiving a semi-static configuration of one or more first parameters; and while the apparatus is configured according to the semi-static configuration: operating the modem clock at a first frequency; and operating the modem clock at a second frequency.

### INTRODUCTION

### Field of the Disclosure

Aspects of the present disclosure relate to wireless communications, and more particularly, to techniques for modem clock frequency adaptation.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes receiving a semi-static configuration of one or more first parameters; and while the apparatus is configured according to the semi-static configuration: operating the modem clock at a first frequency; and operating the modem clock at a second frequency.

Another aspect provides a method for wireless communications by an apparatus. The method includes sending a semi-static configuration of one or more first parameters to a user equipment (UE); and sending, to the UE, signaling indicating a power level mode associated with a modem clock frequency of the UE.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 illustrates an example timeline for communication of a retransmission of a data packet.

FIG. 6A illustrates an example timeline for channel state feedback (CSF) reporting.

FIG. 6B illustrates an example timeline for CSF reporting.

FIG. 7 depicts a method for wireless communications.

FIG. 8 depicts another method for wireless communications.

FIG. 9 depicts aspects of an example communications device.

FIG. 10 depicts aspects of an example communications device.

### DETAILED DESCRIPTION

Aspects of the present disclosure provide apparatuses, methods, processing systems, and computer-readable mediums for modem clock frequency adaptation.

A user equipment (UE) includes a modem in order to be able to communicate (e.g., send or receive) signals in a wireless communications network, such as to communicate with other wireless communications devices in the wireless communications network. The clock frequency at which the modem operates (also referred to as the modem clock frequency) may be configurable, such that the modem can be operated at different clock frequencies. Such a configurable modem clock frequency may be beneficial to balancing between power consumption by the modem and performance of the modem. For example, when relatively higher performance is needed, the modem clock frequency may be set relatively higher, which may consume relatively more power and provide relatively higher performance. When relatively lower performance is needed, the modem clock frequency may be set relatively lower, which may consume relatively less power and provide relatively lower performance.

In some cases, the modem clock frequency of a UE is set based on a semi-static configuration (e.g., radio resource control (RRC) configuration) of the UE. For example, the UE may receive semi-static configuration parameters (e.g., via RRC signaling, such as from a network entity), corresponding to a semi-static configuration, that configure the UE semi-statically such that the semi-static configuration parameters do not change often. For example, the semi-static configuration may remain the same for a number of time periods (e.g., slots) and may not typically change from one such time period (e.g., slot) to the next. Examples of semi-static configuration parameters that may be part of a semi-static configuration may include one or more of: an envelope mode the UE is configured to use for communication (e.g., with a network entity), a number of active component carriers the UE is configured to use for communication (e.g., with a network entity), a subcarrier spacing configuration per carrier the UE is configured to use for communication (e.g., with a network entity), a control channel configuration per carrier the UE is configured to use for communication (e.g., with a network entity), an aggregate bandwidth per carrier the UE is configured to use for communication (e.g., with a network entity), a demodulation reference signal configuration per carrier the UE is configured to use for communication (e.g., with a network entity), a channel state feedback configuration per carrier the UE is configured to use for communication (e.g., with a network entity), other RRC parameters according to 3GPP specifications; and/or the like.

Different semi-static configurations may allow the UE to operate the modem at different modem clock frequencies to support the semi-static configuration. For example, to process a relatively larger number of active component carriers, the UE may operate the modem at a relatively higher modem clock frequency, while to process a relatively smaller number of active component carriers, the UE may operate the modem at a relatively lower modem clock frequency (and save power). For example, different semi-static configurations may be supported by different minimum modem clock frequencies, and a UE may use a (e.g., minimum) modem clock frequency that supports the semi-static configuration of the UE.

In some cases, the UE is configured with a clock look up table (LUT) that maps each combination of semi-static configuration parameters to a particular modem clock frequency. Accordingly, when the UE is configured with a semi-static configuration, the UE maps the semi-static configuration parameters of the semi-static configuration to a modem clock frequency using the clock LUT, and operates the modem at the modem clock frequency.

However, selecting a modem clock frequency based only on a semi-static configuration may not be optimal in some cases. In particular, other configuration parameters of the UE (also referred to as dynamic configuration parameters) may also affect a minimum modem clock frequency that supports the semi-static configuration and a dynamic configuration corresponding to the dynamic configuration parameters. For example, the UE may receive dynamic configuration parameters (e.g., via downlink control information (DCI) signaling, medium access control (MAC) control element (CE), or the like, such as from a network entity), determine dynamic configuration parameters (e.g., based on occurrence of one or more events), and/or predict dynamic configuration parameters (e.g., based on historical occurrence of one or more events) that may affect how the UE operates, and that may change often. For example, the dynamic configuration may change from one time period (e.g., slot) to the next. Examples of dynamic configuration parameters that may be part of a dynamic configuration may include one or more of: a rank (e.g., based on rank indicator) used by the UE for communication, a modulation and coding scheme (MCS) (e.g., based on channel quality indicator (CQI)) used by the UE for communication, a number of resource blocks (RBs) (RB allocation) used by the UE for communication, whether the UE is communicating a first transmission or a retransmission of a data packet, a number of spatial layers used by the UE for communication, a code block size used by the UE for communication, a modulation type used by the UE for communication, a transport block size used by the UE for communication, a channel state feedback (CSF) report configuration for reporting channel state information (CSI) of the UE, whether the UE is configured for uplink or downlink communications, and/or the like.

In certain cases, the UE or network entity may predict or estimate one or more of the dynamic configuration parameters, such as based on one or more of: a network load of the network entity; an uplink buffer status of the UE; a time division duplexing (TDD) configuration of the UE; a frequency division duplex (FDD) configuration of the UE; channel conditions (e.g., signal to noise ratio (SNR), reference signal received power (RSRP), etc.) between the UE and the network entity; a multi-user multiple-input and multiple-output (MU-MIMO) mode of operation of the UE; and/or the like.

Even for a given semi-static configuration, different dynamic configurations may allow the UE to operate the modem at different modem clock frequencies, such as minimum modem clock frequencies, to support the semi-static configuration and dynamic configuration. For example, even with the same semi-static configuration, to process a relatively larger number of resource blocks, the UE may need to operate the modem at a relatively higher minimum modem clock frequency, while to process a relatively smaller number of resource blocks, the UE may need to operate the modem at a relatively lower minimum modem clock frequency.

However, updating the modem clock frequency based on a dynamic configuration of the UE may pose certain technical challenges or problems. For example, tracking and changing the modem clock frequency for each time period (e.g., slot) after the dynamic configuration changes may not be feasible in some cases, as by the time the actual change of dynamic configuration is determined, and the modem clock frequency is changed, the time period may be over and a new change of dynamic configuration may occur. Further generating a clock LUT that maps each combination of semi-static configuration parameters and dynamic configuration parameters to a particular modem clock frequency may be prohibitively large to store in memory, due to the large number of combinations.

Accordingly, in some cases, for a given semi-static configuration, the modem clock frequency is based on a worst case dynamic configuration, such as where the dynamic configuration assumed is that which requires a highest minimum modem clock frequency to support it. Therefore, the clock LUT may map each semi-static configuration to a modem clock frequency that may be the minimum modem clock frequency that supports a worst case dynamic configuration. The UE, accordingly, may operate the modem clock frequency at a higher clock frequency than is actually required, as the UE may actually require a lower clock frequency based on the actual dynamic configuration requiring a lower minimum modem clock frequency than the worst case dynamic configuration. This poses a technical problem, as the UE may consume more power than necessary.

Accordingly, certain aspects discussed herein provide techniques for operating the modem of a UE using different modem clock frequencies, even when the semi-static configuration of the UE remains the same. Such techniques may provide a technical benefit of power savings at the UE, by allowing the UE to operate at lower modem clock frequencies than those needed to support a worst case dynamic configuration for a given semi-static configuration.

For example, certain aspects discussed herein provide techniques for predicting a dynamic configuration of a UE for a given time period, before occurrence of the time period, and operating a modem clock of the modem of the UE at a modem clock frequency (e.g., minimum modem clock frequency) that supports the predicted dynamic configuration, such as instead of a clock frequency that supports a worst case dynamic configuration. Certain aspects discussed herein provide different techniques for predicting or determining the dynamic configuration of the UE.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

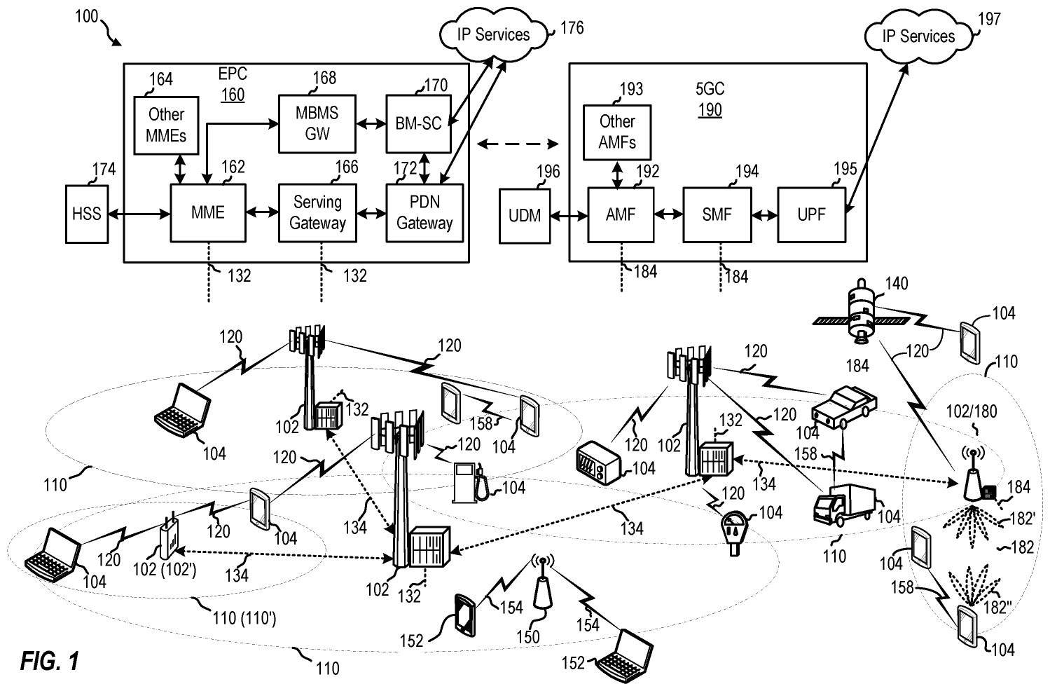

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (CNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

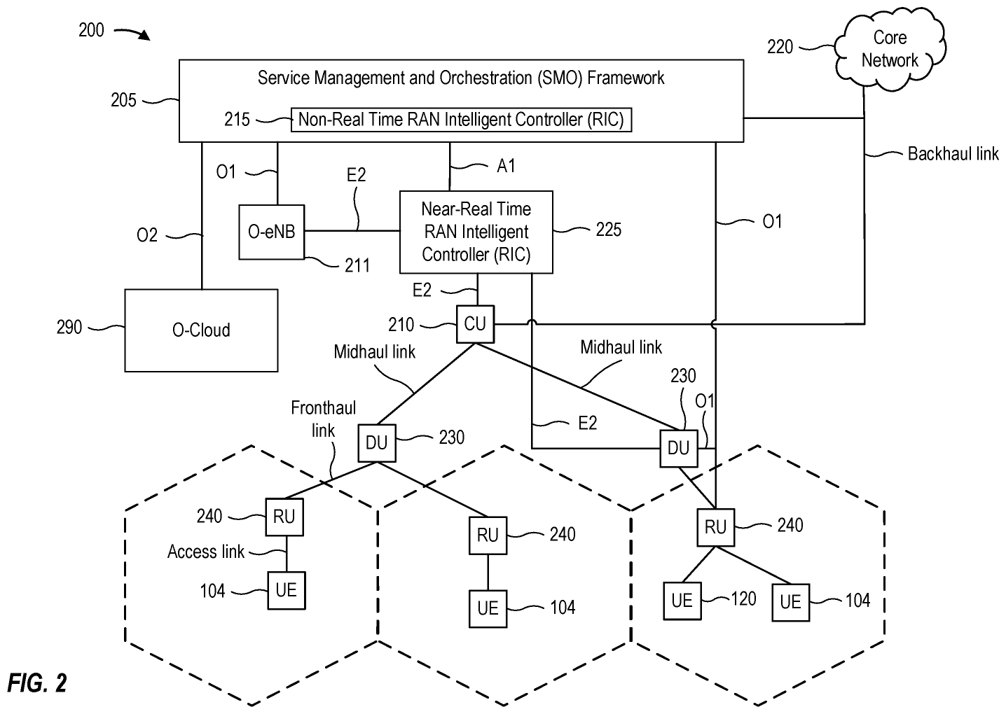

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHZ, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′ BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-NB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

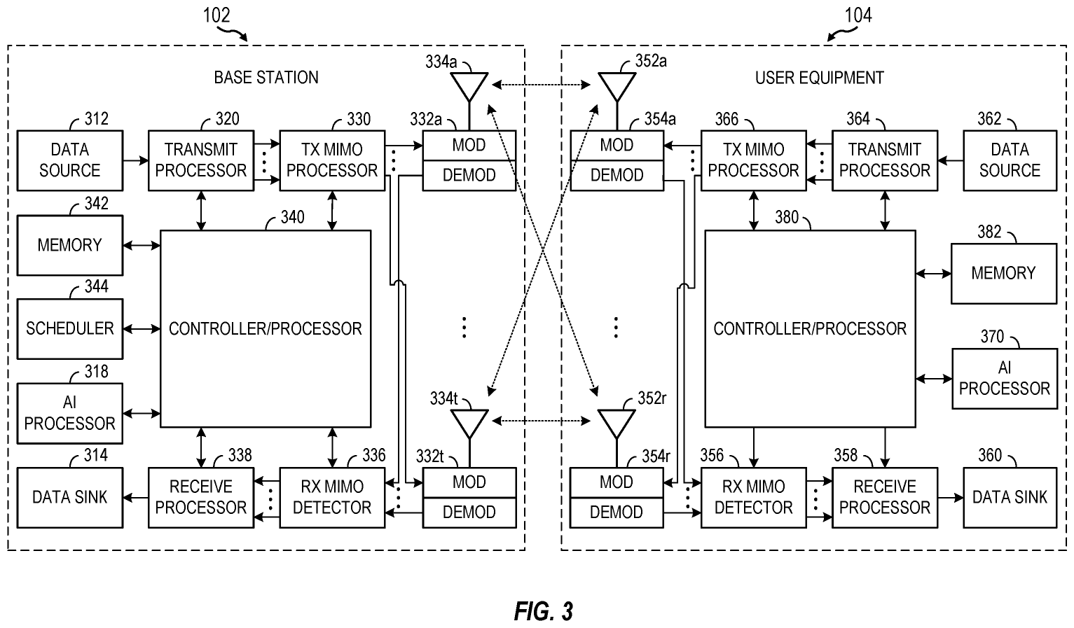

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352ₐ₋ᵣ (collectively 352), transceivers 354ₐ₋ᵣ (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332ₐ-332t. Each modulator in transceivers 332ₐ-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332ₐ-332t may be transmitted via the antennas 334ₐ-334ₜ, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

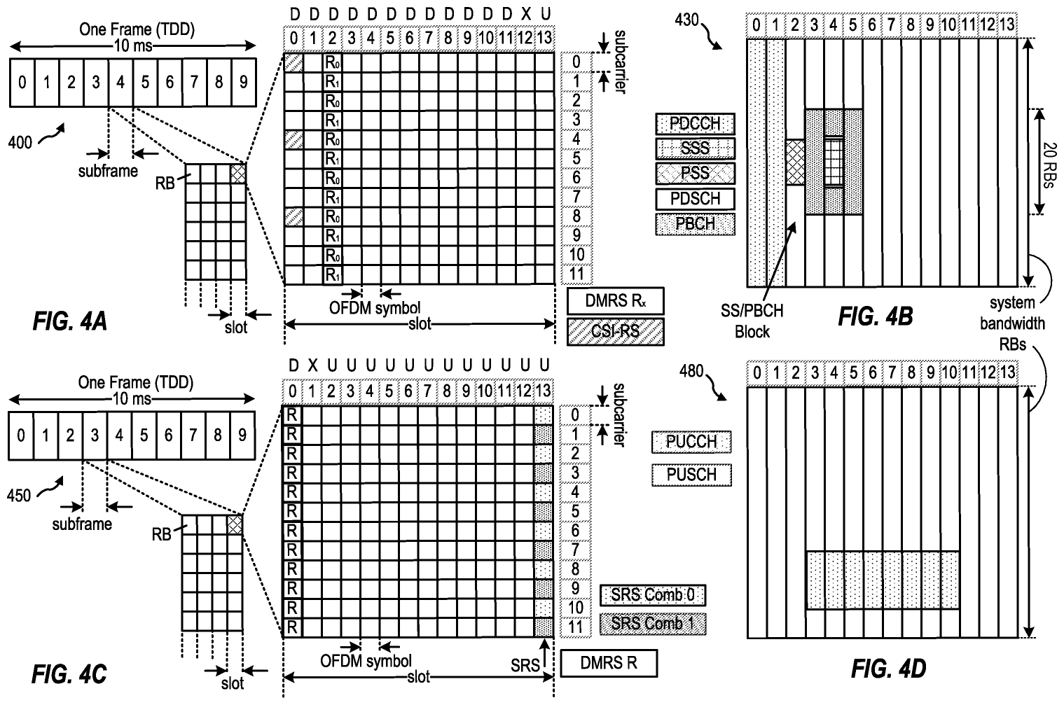

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIG. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where μ is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Operating a Modem at Different Clock Frequencies for a Given Semi-Static Configuration

As discussed, certain aspects herein provide techniques for operating a modem (e.g., of a UE such as UE 104 of FIGS. 1 and 3) at different clock frequency for a given semi-static configuration. As an example, the modem of UE 104 of FIG. 3 may include transceivers 354a-354r, RX MIMO detector 356, receive processor 358, transmit processor 364, TX MIMO processor 366, and controller/processor 380, each of which may be operated at the different clock frequency for the given semi-static configuration.

For example, a UE may receive a semi-static configuration. The UE, while configured according to the semi-static configuration, may operate the modem at a first frequency, such as for a first time period. Further, the UE, while configured according to the semi-static configuration, may operate the modem at a second frequency different than the first frequency, such as for a second time period. For example, a dynamic configuration of the UE may change between the first time period and the second time period. In certain aspects, the UE is configured to switch from operating the modem at a first frequency to operating the modem at a second different frequency based on one or more criteria being met, such as occurrence of one or more events, prediction of one or more parameter values meeting one or more thresholds, prediction of occurrence one or more events, or the like. Operating the modem at different clock frequencies (also referred to as operating the modem clock at different frequencies) for the same semi-static configuration may provide power savings over operating the modem at only one clock frequency for a given semi-static configuration.

### Aspects Related to Operating a Modem at Different Clock Frequencies Based on Transmission Type

In certain aspects, a UE (e.g., UE 104 of FIGS. 1 and 3) is configured to adjust operation of the modem clock of the modem of the UE for a time period based on the UE being predicted or configured to receive a retransmission of a data packet during the time period. For example, in certain cases, a UE may require a higher minimum modem clock frequency for receiving and processing retransmissions of data packets, as compared to a minimum clock frequency for receiving and processing initial or first (in time) transmissions of data packets.

For example, a wireless communications device (e.g., network entity) may send a retransmission of a data packet to the UE when an initial transmission of the data packet to the UE is not successfully received and decoded by the UE, such as using a hybrid automatic repeat request (HARQ) procedure. At any given time, a UE may be configured to receive one or more data packets, which the UE does not successfully receive and decode. The UE, accordingly, may start a HARQ process for each such data packet, where for each HARQ process the UE stores, in a retransmission buffer, data received for the data packet that cannot be decoded (e.g., and which may be combined with retransmission(s) of the data packet to enhance successful decoding probability). The UE may attempt to receive respective retransmission(s) of each of the one or more data packets for which the UE has started a respective HARQ process to try to decode the data packets. Each HARQ process may be associated with a retransmission window (e.g., a time period) having a start time (e.g., when the initial data packet is received) and an end time (e.g., a defined duration after the start). A given HARQ process may be considered to be in a failing state, so long as the HARQ process is active (e.g., the retransmission window has not ended), and the data packet associated with the HARQ process has not yet been successfully received and decoded by the UE. The HARQ process for a given data packet may end and become inactive when either of the retransmission window for the HARQ process elapses/ends or the data packet is successfully received and decoded by the UE. In certain aspects, when a given HARQ process ends, the data associated with the data packet of the HARQ process is flushed from the retransmission buffer. Therefore, an empty retransmission buffer may indicate there are no active HARQ processes. In certain aspects, when all retransmission windows of all HARQ processes of the UE end/elapse, the UE determines there are no active HARQ processes.

Certain aspects herein provide for the UE to operate the modem clock at a first frequency for receiving an initial transmission of a data packet, such as operate the modem clock at the first frequency in a slot configured to carry an initial transmission of a data packet, such as according to a downlink grant. Further, certain aspects provide for the UE to operate the modem clock at a second frequency for receiving a retransmission of the data packet, such as operate the modem clock at the second frequency in a slot configured to carry the retransmission of the data packet. In certain aspects the second frequency is higher than the first frequency.

In some cases, when operating the modem clock according to the first frequency, the UE may achieve power savings over operating the modem clock based on a semi-static configuration of the UE alone, where the modem clock may be operated at a higher frequency based on a worst case assumption of the UE being configured to receive a retransmission. In certain aspects, the first frequency may be determined using an assumption of a dynamic configuration of the UE assuming a worst-case for dynamic configuration parameters other than related to whether the transmission is an initial or retransmission (e.g., MCS, TB size, and/or channel conditions (e.g., SNR)), and that the UE is configured to receive an initial transmission.

In certain aspects, the second frequency may be determined using an assumption of a dynamic configuration of the UE assuming a worst-case for dynamic configuration parameters other than related to whether the transmission is an initial or retransmission (e.g., MCS, TB size, and/or channel conditions (e.g., SNR)), and that the UE is configured to receive a retransmission, such that the second frequency is higher than the first frequency.

In certain aspects, the second frequency may be determined using an assumption of a dynamic configuration of the UE based on dynamic configuration parameters of the actual dynamic configuration (e.g., MCS, TB size, and/or channel conditions (e.g., SNR)) of the UE when receiving the initial transmission other than the transmission type, and that the UE is configured to receive a retransmission. In certain aspects, where there are multiple failing HARQ processes, the second frequency may be determined using an assumption of a dynamic configuration of the UE based on dynamic configuration parameters of the actual dynamic configuration (e.g., MCS, TB size, and/or channel conditions (e.g., SNR)) of the UE when receiving the initial transmission associated with the failing HARQ process requiring a highest minimum clock frequency among the currently failing HARQ processes, and that the UE is configured to receive a retransmission. Accordingly, when operating the modem clock according to the second frequency, the UE may achieve power savings over operating the modem clock based on a semi-static configuration of the UE alone, where the modem clock may be operated at a higher frequency based on a worst case assumption of the UE being configured to receive a retransmission.

In certain aspects, the UE is configured to predict or determine a time period (e.g., one or more slots) configured for communication of a retransmission of a data packet. For example, the UE may be configured to determine the time period based on a transmission time of a negative acknowledgment (NACK) associated with the initial transmission of the data packet. For example, the UE may receive a signal corresponding to a transmission of a data packet or be configured to receive a transmission of a data packet, from a wireless communications device (e.g., network entity, other UE, etc.) during a first time period (e.g., a first slot). The UE may not be able to successfully receive and decode the data packet. Accordingly, the UE may transmit a NACK to the wireless communications device, to inform the wireless communications device that the data packet was not received and decoded. In response to the NACK, the wireless communications device may send a retransmission of the data packet to the UE.

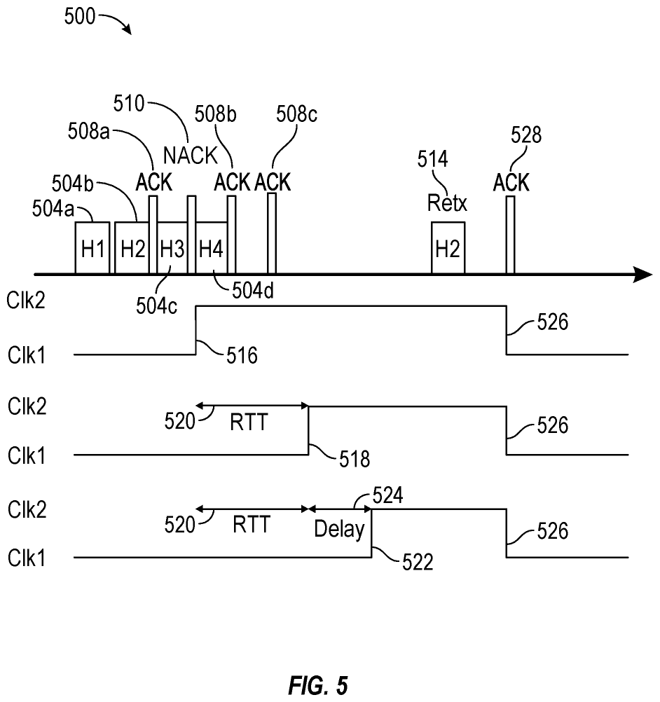

FIG. 5 illustrates an example timeline 500 for communication of a retransmission of a data packet. As shown, the UE receives or is scheduled to receive data packets 504a-d during time periods (e.g., slots) from the wireless communications device. In this example, the initial transmissions of data packets 504a, 504c, and 504d are successfully received and decoded by the UE. Accordingly, the UE is configured to transmit acknowledgements (ACKs) 508a, 508b, and 508c, to the wireless communications device indicating to the wireless communications device that the UE successfully received and decoded data packets 504a, 504c, and 504d, respectively. However, the initial transmission of data packet 504b is not successfully received and decoded, and therefore the UE transmits NACK 510 to the wireless communications device indicating to the wireless communications device that the UE did not successfully receive and decode data packet 504b. Further, the UE starts a HARQ process for data packet 504b. Accordingly, at a time period (e.g., slot), the wireless communications device retransmits data packet 504b as data packet 514. In this example, the UE successfully receives the retransmitted data packet 514, and sends an ACK 528 to the wireless communications device accordingly, and ends the HARQ process associated with the data packet. It should be noted that the example shown is just one example, and techniques here may be used for any number of packets with any number of failing HARQ processes and retransmissions per packet.

In certain aspects, the UE is configured to predict or determine the time period configured for communication of a retransmission of a data packet starts at a first time after the UE transmits NACK 510. In certain aspects, the first time after the UE transmits NACK 510 is a first slot 516 or other communication time interval in time after transmission of the NACK 510. For example, the UE may assume the retransmission of the data packet may be transmitted any time after the UE transmits NACK 510.

In certain aspects, the first time after the UE transmits NACK 510 is a first slot 518 in time after a first delay time after transmission of the NACK 510, the first delay time equaling a round trip time (RTT) 520 between the UE and the wireless communications device. The RTT 520 may be the time it takes for the UE to transmit a packet to the wireless communications device and receive a response packet from the wireless communications device over a wireless channel. The UE may determine the RTT 520 based on measuring RTT of previous communications with the wireless communications device. In another example, the UE may predict the RTT 520, such as based on a minimum delay assumption, historical measurements of RTT, estimated network load (e.g., based on historical delay or other factors, passive monitoring of the frequency bandwidth used for communication, etc.), and/or the like. For example, the UE may assume that for the wireless communications device to receive NACK 510 and transmit data packet 514, and the UE to receive data packet 514, at least an RTT 520 must pass after transmission of the NACK 510, as that is the minimum time for communication of NACK 510 and data packet 514 between the UE and wireless communications device to occur over the wireless communications channel.

In certain aspects, the first time after the UE transmits NACK 510 is a first slot 522 in time after a first delay time after transmission of the NACK 510, the first delay time equaling a sum of the RTT 520 between the UE and the wireless communications device and an additional delay time 524 based on one or more delay parameters. For example, the UE may predict additional delay time 524 before receiving data packet 514 after transmitting NACK 510. The additional delay time 524 may be calculated based on one or more delay parameters (e.g., corresponding to configuration parameters of the UE), such as one or more of: a number of HARQ processes configured at the UE (e.g., by RRC signaling), a number of failed HARQ processes at the UE, a connected mode discontinuous reception (CDRX) configuration of the UE, a data scheduling pattern of the UE, such as a past uplink/downlink communication configuration pattern of the UE, and/or the like.

In certain aspects, the UE is configured to operate a modem clock of the UE at the first frequency (clk1) when there are no HARQ processes active at the UE. For example, with respect to timeline 500, the UE may operate the modem clock at the first frequency at least starting at the reception of data packet 504a. In certain aspects, the UE is configured to switch to operating the modem clock of the UE at the second frequency (clk2) starting at the first time after the UE transmits NACK 510. In certain aspects, the UE is configured to switch to operating the modem clock of the UE from the second frequency back to the first frequency after one or more (e.g., all) retransmission windows of HARQ processes of the UE elapse, or one or more retransmission buffers (e.g., all) of the UE are empty. In the example of timeline 500, the UE may switch to operating the modem clock of the UE from the second frequency back to the first frequency after receiving and decoding data packet 514 and transmitting the ACK 528 acknowledging receipt and decoding of the data packet 514 at time 526.

### Aspects Related to Operating a Modem at Different Clock Frequencies Based on Channel State Feedback

In certain aspects, a UE (e.g., UE 104 of FIGS. 1 and 3) is configured to adjust operation of the modem clock of the modem of the UE for a time period (e.g., one or more slots) based on the UE being predicted or scheduled to receive one or more reference signals (e.g., channel state information (CSI) reference signals (CSI-RSs)) in one or more resources (e.g., CSI-RS resources) during the time period. The UE may measure the one or more reference signals to provide channel state feedback (CSF), such as to a wireless communications device that transmitted the one or more reference signals. For example, in certain cases, a UE may require a higher minimum modem clock frequency for receiving and processing reference signals, as compared to a minimum clock frequency for receiving and processing other signals (e.g., downlink control information, control information, etc.). Certain aspects are discussed with respect to CSI-RSs as example reference signals, but the techniques discussed herein may be used with other types of reference signals.

In certain wireless communication systems, closed-loop feedback associated with a communication channel may be used to dynamically adapt communication link parameters (e.g., modulation and coding scheme, beamforming, multiple-input and multiple-output (MIMO) layers, etc.) according to time varying channel conditions. For example, channel conditions may change over time due to UE mobility, weather conditions, scattering, fading, interference, noise, etc. A UE may report CSI to a wireless communications device, such as a network entity (e.g., a base station), which may adjust certain communication parameters in response to the CSI from the UE. Link adaptation (such as adaptive modulation and coding) with various modulation schemes and channel coding rates may be applied to certain communication channels. Note that CSI may also be referred to as channel state feedback (CSF).

As an example, a UE may measure a reference signal (e.g., CSI-RS) and estimate the channel state based on measurement(s) of that reference signal. The UE may report an estimated channel state to the wireless communications device in the form of CSI as a CSF report. In certain aspects, the CSI may indicate channel properties of a communication link between the wireless communications device and the UE. For example, the CSI may indicate the effect of, for example, scattering, fading, and pathloss of a signal propagating across the communication link. As an example, a CSI report may include a channel quality indicator (CQI), PMI, a layer indicator (LI), a rank indicator (RI), a reference signal received power (RSRP), a signal-to-interference plus noise ratio (SINR), etc. Additional or other information may be included in a CSI report.

In certain cases, a UE may be configured to report the CSI as a CSF report on a periodic basis (referred to as periodic CSF reporting). For example, the UE may be configured (e.g., semi-statically based on signaling received from a network entity, such as RRC signaling; or semi-persistently based on signaling received from a network entity, such as media access control (MAC) control element (MAC-CE) signaling) with periodic CSI-RS resources to measure CSI-RSs. The UE may accordingly send, to a network entity, a CSF report with a periodicity. Each CSF report may indicate channel properties based on measurements of periodic reference signals and/or interference measurements.

In some cases, a UE may be configured to report the CSI as a CSF report on an aperiodic basis (referred to as aperiodic CSF reporting), for example, in response to certain events and/or trigger states. In certain aspects, a network entity may send, to the UE, a request for certain CSI via downlink control information (DCI), which may identify an aperiodic CSI trigger state that maps to a particular CSI report configuration, such that the UE sends a CSF report to the network entity. In certain aspects, the UE may be configured (e.g., dynamically based on signaling received from a network entity, such as DCI) with one or more aperiodic CSI-RS resources to measure one or more aperiodic CSI-RSs.

Certain aspects herein provide for the UE to operate the modem clock at a first frequency when not predicted or scheduled to receive and/or process one or more reference signals, such as operate the modem clock at the first frequency in a slot configured to carry a DCI. Further, certain aspects provide for the UE to operate the modem clock at a second frequency for receiving and/or processing one or more reference signals, such as operate the modem clock at the second frequency during a time period (e.g., one or more slots) predicted or scheduled to carry one or more reference signals. In certain aspects the second frequency is higher than the first frequency.

In some cases, when operating the modem clock according to the first frequency, the UE may achieve power savings over operating the modem clock based on a semi-static configuration of the UE alone, where the modem clock may be operated at a higher frequency based on a worst case assumption of the UE being configured to receive and/or process one or more reference signals. In certain aspects, the first frequency may be determined using an assumption of a dynamic configuration of the UE assuming a worst-case for dynamic configuration parameters other than related to reference signal reception/processing (e.g., MCS, TB size, and/or channel conditions (e.g., SNR)), and that the UE is configured to not receive and/or process one or more reference signals.

In certain aspects, the second frequency may be determined using an assumption of a dynamic configuration of the UE assuming a worst-case for dynamic configuration parameters other than related to reference signal reception/processing (e.g., MCS, TB size, and/or channel conditions (e.g., SNR)), and that the UE is configured to receive and/or process one or more reference signals, such that the second frequency is higher than the first frequency. In certain aspects, the second frequency may be determined based on assumption of a dynamic configuration that is based on an indication of a latency type associated with the CSF reporting. For example, as part of the configuration signaling for the CSF reporting (e.g., DCI for aperiodic CSF reporting), the signaling (e.g., DCI) may include an indication of a latency type, such as low, medium, or high. For a low latency type, the second frequency may be set relatively higher, as compared to the medium latency type and the high latency clock type. For a medium latency type, the second frequency may be set relatively higher, as compared to the high latency. Accordingly, in certain aspects, even when the UE is configured to receive and/or process one or more reference signals, the second frequency at which the modem clock is operated may be adjusted, thereby leading to power savings over always assuming a low latency clock type.

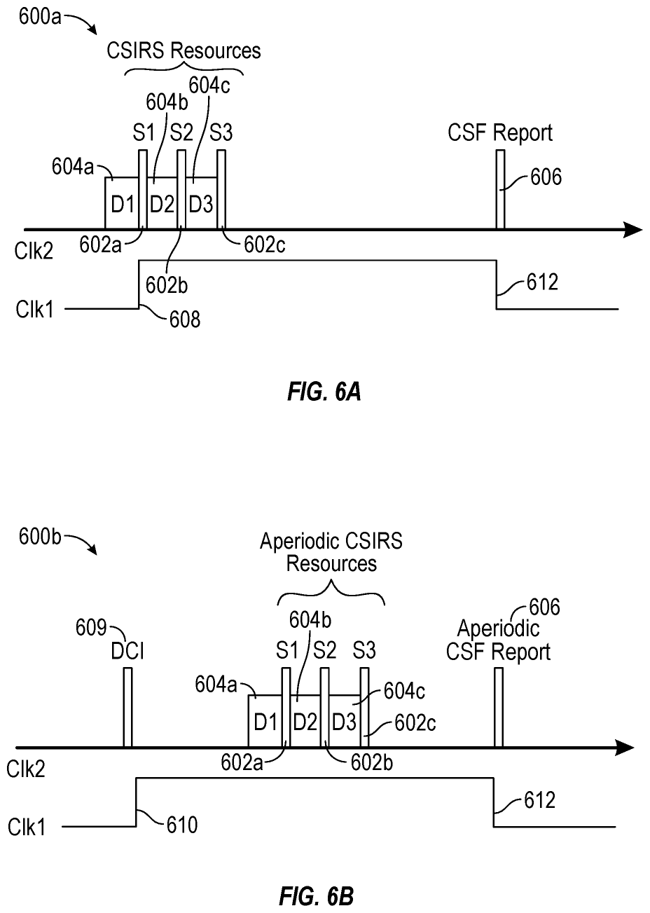

FIG. 6A illustrates an example timeline 600a for CSF reporting. The CSF reporting in FIG. 6A may be periodic or aperiodic CSF reporting. As shown, the UE is scheduled to receive, from a wireless communications device, CSI-RSs 602a-c in CSI-RS resources occurring at the end of downlink time periods (e.g., slots) 604a-c, respectively. Further, the UE is configured to transmit, to the wireless communications device, a CSF report 606, after receiving and measuring the CSI-RSs 602a-c.

In certain aspects, the UE is configured to predict or determine the time period for receiving and/or processing one or more reference signals starts/begins at a first communication time interval (e.g., first slot) in time of one or more communication time intervals (e.g., slots) including resources (e.g., CSI-RS resources) for communicating the one or more reference signals. For example, the UE may be configured with one or more resources (e.g., CSI-RS resources) to measure for a given CSF report, such as for an aperiodic CSF reporting, or corresponding to one CSF reporting of a periodic CSF reporting. The time period may start at occurrence of the first resource in time of the one or more resources, such that communication of the first reference signal in time of the one or more reference signals is received during the time period. With respect to the example timeline 600a, the UE is configured to receive and process CSI-RSs 602a-c in CSI-RS resources for CSF report 606. The first CSI-RS resource in time is the CSI-RS resource including CSI-RS 602a. Accordingly, the time period may begin at time 608, which may be the slot in which CSI-RS 602a is communicated.

In certain aspects, the UE is configured to operate a modem clock of the UE at the first frequency (clk1) when there are not resources predicted or scheduled for receiving reference signals. For example, with respect to timeline 600a, the UE may operate the modem clock at the first frequency prior to time period 608. In certain aspects, the UE is configured to switch to operating the modem clock of the UE at the second frequency (clk2) starting at the time at which the first reference signal for the CSF report is communicated. For example, with respect to timeline 600a, the UE may switch to operating the modem clock of the UE at the second frequency at time period 608. In certain aspects, the UE is configured to switch to operating the modem clock of the UE from the second frequency back to the first frequency after the UE transmits the CSF report. In the example of timeline 600a, the UE may switch to operating the modem clock of the UE from the second frequency back to the first frequency after transmitting CSF report 606 at time 612.

FIG. 6B illustrates an example timeline 600b for CSF reporting. The CSF reporting in FIG. 6B is similar to the CSF reporting in timeline 600a, except timeline 600b is only for aperiodic CSF reporting, and accordingly includes communication of DCI 609 configuring the aperiodic CSF reporting.

In certain aspects, the UE is configured to predict or determine the time period for receiving and/or processing one or more reference signals starts/begins at a first communication time interval (e.g., first slot) in time after receiving a DCI configuring the one or more resources for communicating one or more reference signals for the CSF report. With respect to the example timeline 600b, the time period may begin at time 610, which may be the slot after which DCI 609 is communicated.

In certain aspects, the UE is configured to operate a modem clock of the UE at the first frequency (clk1) when there are not resources predicted or scheduled for receiving reference signals. For example, with respect to timeline 600b, the UE may operate the modem clock at the first frequency prior to time period 610. In certain aspects, the UE is configured to switch to operating the modem clock of the UE at the second frequency (clk2) starting at the first time interval (e.g., slot) in time after reception of DCI configuring the CSF reporting. For example, with respect to timeline 600b, the UE may switch to operating the modem clock of the UE at the second frequency at time period 610 after reception of DCI 609. In certain aspects, the UE is configured to switch to operating the modem clock of the UE from the second frequency back to the first frequency after the UE transmits the CSF report. In the example of timeline 600b, the UE may switch to operating the modem clock of the UE from the second frequency back to the first frequency after transmitting CSF report 606 at time 612.

### Aspects Related to Operating a Modem at Different Clock Frequencies Based on Predicted Dynamic Configuration Parameters

In certain aspects, a UE (e.g., UE 104 of FIGS. 1 and 3) is configured to adjust operation of the modem clock of the modem of the UE for a time period (e.g., one or more slots) based on the UE being predicted to be configured with certain dynamic configuration parameters during the time period.

For example, the UE may receive an uplink grant or a downlink grant, from a network entity, scheduling uplink or downlink communication with the network entity, respectively, for the UE for a time period. The uplink grant or downlink grant may indicate certain dynamic configuration parameters for the UE to use for communication during the time period, such as whether the time period is for uplink or downlink communication (e.g., based on it being an uplink grant or a downlink grant), a transport block (TB) size, an MCS, a rank, an RB allocation, bandwidth part (BWP) size, number of spatial layers, and/or the like.

The UE may be configured to predict, such as using a deterministic model based on past historical data, statistical analysis based on past historical data, or a machine learning model (e.g., trained on past historical data, or other training data), the dynamic configuration parameters expected to be received in an uplink or downlink grant for the UE for a time period, and accordingly operate the modem clock of the UE at a frequency based on the predicted dynamic configuration parameters, such as a minimum frequency that supports the predicted dynamic configuration parameters and the semi-static configuration of the UE.

In certain aspects, the UE may be configured to predict whether the UE will receive an uplink grant or a downlink grant for the time period, as in whether the time period will be for uplink communication or downlink communication, based on one or more of: a network configuration of the UE (e.g., whether uplink and/or downlink resources are scheduled periodically), an uplink buffer status of the UE (e.g., an uplink buffer with data over a threshold may make an uplink grant more likely), a time division duplexing (TDD) configuration of the UE (e.g., indicating which time resources are for uplink versus downlink), a frequency division duplexing (FDD) configuration of the UE (e.g., indicating which frequency resources are for uplink versus downlink), and/or the like.

In certain aspects, the UE may be configured to predict a rank and/or MCS level that will be indicated in an uplink grant or a downlink grant for the time period, based on one or more of: channel conditions between the UE and the network entity (e.g., based on a rank indicator (RI) report or channel quality indicator (CQI), such as determined by the UE as part of a CSF report), an estimate of RI or CQI by the UE, a multi-user multiple-input and multiple-output (MU-MIMO) mode of operation (e.g., predicted via DMRS detection, etc.), and/or the like. For example, the UE may determine a relatively higher modem clock frequency if the rank and/or MCS requires a relatively higher minimum modem clock frequency for processing, and a relatively lower modem clock frequency if the rank and/or MCS requires a relatively lower minimum modem clock frequency for processing. In another example, a UE can assume a worst case rank and/or MCS to account for MU-MIMO enable/disable being indicated for the time period, and determine a minimum modem clock frequency accordingly.

In certain aspects, the UE may be configured to predict an RB allocation (e.g., number of RBs for which the UE is scheduled to communicate) and/or BWP size that will be indicated in an uplink grant or a downlink grant for the time period, based on one or more of: a network load, an expected scheduling rate or network load, and/or the like.

In certain aspects, the UE may be configured to determine the modem clock frequency for the time period based on a maximum TB size received in a past time window (e.g., number of ms). In some aspects, the UE may assume the maximum TB size plus a margin size, which may depend on CQI/RI estimates. The UE may set the modem clock frequency as a (e.g., minimum) clock frequency that supports the maximum TB size received in a past time window plus the margin size.

In certain aspects, the UE may be configured to determine the modem clock frequency for the time period based on a predicted number of spatial layers to use for communication and/or a predicted uplink TB size to use for communication. The UE may set the modem clock frequency as a (e.g., minimum) clock frequency that supports the predicted number of spatial layers to use for communication and the predicted uplink TB size to use for communication.

In certain aspects, the UE may be configured to determine a (e.g., minimum) clock frequency needed for uplink communication (e.g., UL clock frequency) for the time period and a (e.g., minimum) clock frequency needed for downlink communication (e.g., DL clock frequency) for the time period, based on predicted dynamic configuration parameters other than whether the communication is uplink or downlink communication, and set the modem clock frequency as the greater of the UL clock frequency and the DL clock frequency.

In certain aspects, if the UE sets a modem clock frequency for the time period, and the UE fails to successfully decode a communication (e.g., because the TB size was higher than predicted), the UE may increase the modem clock frequency for subsequent time periods (e.g., slots).

### Aspects Related to Operating a Modem at Different Clock Frequencies Based on Network Assistance

In certain aspects, a UE (e.g., UE 104 of FIGS. 1 and 3) is configured to adjust operation of the modem clock of the modem of the UE for a time period (e.g., one or more slots) based on an indication of a power level mode received (e.g., in a DCI) from a network entity (e.g., BS 102 depicted and described with respect to FIGS. 1 and 3 or a disaggregated base station depicted and described with respect to FIG. 2.) or other wireless communications device.

For example, a plurality of power level modes may be defined, such as low power mode, mid power mode, and higher power mode. In certain aspects, the UE, such as part of capability reporting, such as during RRC configuration, is configured to send, to the network entity, a maximum capability of the UE for each of the plurality of power level modes. For example, in certain aspects, a maximum capability may indicate one or more maximum values for one or more parameters of the UE that the UE is capable of operating according to, such as one or more dynamic configuration parameters and/or one or more semi-static configuration paramaters, such as TB size, RB allocation, rank, a number of DMRS thresholds, and/or the like.

In certain aspects, such as based on the UE capability information for each of the plurality of power level modes, the network entity sends to the UE an indication of one of the power level modes (e.g., using a DCI). In certain aspects, the indication (e.g., DCI) further indicates a time window/time period for which the UE should operate in the power level mode, such as a number of slots (e.g., 8, 16, 32, 64, 128, 256, 512, or 1024), until a new power level mode is indicated, etc. Accordingly, the UE may operate in the indicated power level mode for the number of slots, or until a new power level mode is indicated (e.g., in DCI). Accordingly, the UE operates according to the power level mode, such as for the time window, meaning it assumes the maximum configuration of parameters it reported for the power level mode, and sets the modem clock frequency based on the maximum configuration for the power level mode, such as a minimum clock frequency that supports the maximum configuration for the power level mode.

In certain aspects, the indication (e.g., DCI) may indicate a second power level mode at which the UE should operate after the time window/time period. Accordingly, after the time window/time period ends, the UE may operate according to the second power level mode, meaning it assumes the maximum configuration of parameters it reported for the second power level mode, and sets the modem clock frequency based on the maximum configuration for the second power level mode, such as a minimum clock frequency that supports the maximum configuration for the second power level mode

In certain aspects, outside the time window, the UE operations the modem clock at a frequency based on the semi-static configuration of the UE, such as assuming worst case for dynamic configuration of the UE.

In certain aspects, the UE can request a particular power level mode for a particular time window, and may send a request to the network entity for the power level mode. In certain aspects, the UE may operate according to the requested power level mode during the time window, without further signaling from the network entity. In certain aspects, the UE may wait to receive a further indication (e.g., in DCI) confirming to operate in the requested power level mode (e.g., the DCI indicating the power level mode, and in some cases the time window), and operate according to the requested power level mode during the time window when receiving the indication.

In certain aspects, the UE and/or network entity determines the power level mode based on one or more parameters, such as network load, UE traffic requirement (e.g., at app level, physical level, etc.), and/or channel conditions between the UE and network entity (e.g., SNR). For example, with a higher network load, the network entity may determine a higher power level mode to operate the modem clock at a higher frequency to send data quickly to reduce time of use of the network. As another example, where the UE has higher traffic requirements, the UE may determine a higher power level to meet the throughput requirement. As another example, where the channel conditions are poor, the UE or network entity may determine a higher power level to account for poor channel conditions.

### Example Operations

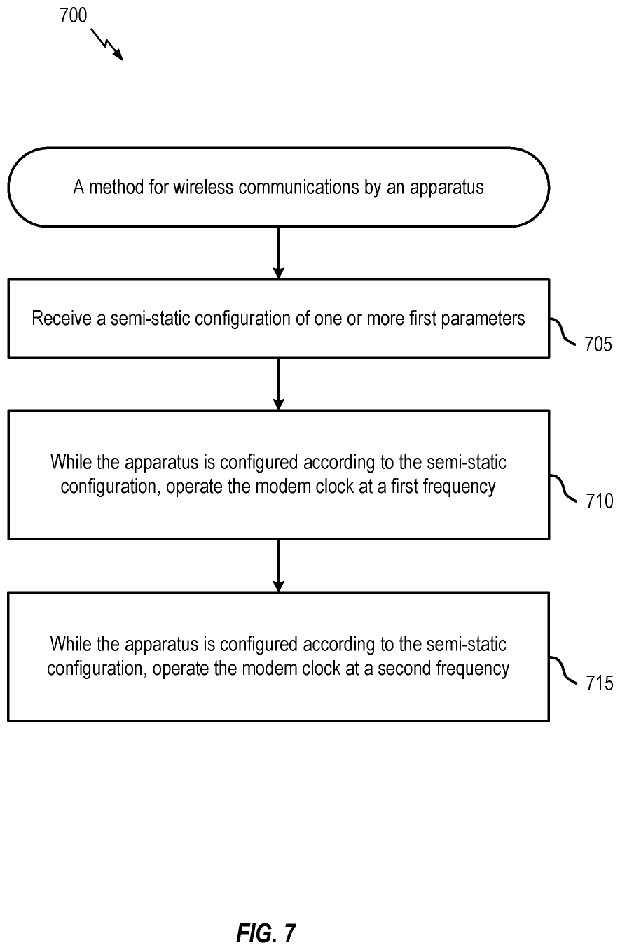

FIG. 7 shows a method 700 for wireless communications by an apparatus, such as UE 104 of FIGS. 1 and 3.

Method 700 begins at block 705 with receiving a semi-static configuration of one or more first parameters. For example, a UE may receive semi-static configuration parameters (e.g., via RRC signaling, such as from a network entity), corresponding to a semi-static configuration, that configure the UE semi-statically such that the semi-static configuration parameters do not change often.

Method 700 then proceeds to block 710 with, while the apparatus is configured according to the semi-static configuration, operating the modem clock at a first frequency.

Method 700 then proceeds to block 715 with, while the apparatus is configured according to the semi-static configuration, operating the modem clock at a second frequency. In certain aspects, a UE is configured to switch from operating the modem at a first frequency to operating the modem at a second different frequency based on one or more criteria being met, such as occurrence of one or more events, prediction of one or more parameter values meeting one or more thresholds, prediction of occurrence one or more events, or the like. Operating the modem at different clock frequencies (also referred to as operating the modem clock at different frequencies) for the same semi-static configuration may provide power savings over operating the modem at only one clock frequency for a given semi-static configuration.

In certain aspects, the one or more first parameters comprise one or more of: an envelope mode, a number of active component carriers, a subcarrier spacing configuration per carrier, a control channel configuration per carrier, an aggregate bandwidth per carrier, a demodulation reference signal configuration per carrier, or a channel state feedback configuration per carrier.

In certain aspects, block 715 includes, based on a first criteria, switching operation of the modem clock from the first frequency to the second frequency for a time period; wherein the first criteria comprises the apparatus being predicted to receive a retransmission of a data packet during the time period.

In certain aspects, method 700 further includes transmitting a negative acknowledgement, to a network entity, with respect to attempted reception of the data packet, wherein: the apparatus being predicted to receive the retransmission of data packet during the time period is based on transmission of the negative acknowledgement; and the time period begins at a time after transmission of the negative acknowledgement.

In certain aspects, the time after transmission of the negative acknowledgement comprises one of: a first slot in time after transmission of the negative acknowledgement; a first slot in time after a first delay time after transmission of the negative acknowledgement, the first delay time equaling a round trip time between the apparatus and the network entity; or a first slot in time after a second delay time after transmission of the negative acknowledgement, the second delay time equaling a sum of a round trip time between the apparatus and the network entity and an additional delay time based on one or more delay parameters.

In certain aspects, the one or more delay parameters comprise one or more of: a number of HARQ processes configured at the apparatus, a number of failed HARQ processes at the apparatus, a CDRX configuration of the apparatus, or a data scheduling pattern of the apparatus.

In certain aspects, method 700 further includes switching operation of the modem clock from the second frequency to the first frequency based on at least one of: elapse of one or more retransmission windows; or one or more retransmission buffers being empty.

In certain aspects, the second frequency is based on one or more configuration parameters for transmission of the data packet.

In certain aspects, block 715 includes, based on a first criteria, switching operation of the modem clock from the first frequency to the second frequency for a time period; wherein the first criteria comprises the apparatus being scheduled to receive one or more CSI-RSs in one or more CSI-RS resources during the time period.

In certain aspects, the time period begins at one of: a first slot in time of one or more slots including the one or more CSI-RS resources; or a first slot in time after reception of a downlink control information configuring the one or more CSI-RS resources.

In certain aspects, method 700 further includes receiving a DCI configuring the one or more CSI-RS resources, the DCI indicating a latency type, wherein the second frequency is based on the latency type.

In certain aspects, method 700 further includes switching operation of the modem clock from the second frequency to the first frequency based on transmission of a channel state feedback report based on the one or more CSI-RSs.

In certain aspects, block 710 includes operating the modem clock at the first frequency for a time period; and the first frequency is based on a predicted configuration of one or more second parameters associated with the time period, the one or more second parameters being different than the one or more first parameters.

In certain aspects, method 700 further includes predicting the predicted configuration of the one or more second parameters based on one or more of: a network load; an uplink buffer status of the apparatus; a time division duplexing configuration of the apparatus; a frequency division duplex configuration of the apparatus; channel conditions between the apparatus and a network entity; or a MU-MIMO mode of operation during the time period.

In certain aspects, the one or more second parameters comprise one or more of: whether the time period is configured for uplink or downlink communications; a rank used for communication during the time period; a modulation and coding scheme used for communication during the time period; or a number of resource blocks scheduled for the apparatus for communication during the time period.

In certain aspects, method 700 further includes receiving signaling indicating a power level mode from a network entity, wherein the first frequency is based on the power level mode.

In certain aspects, method 700 further includes sending, to the network entity, a maximum capability for one or more parameters for each of a plurality of power level modes including the power level mode.

In certain aspects, the one or more parameters comprise one or more of: an envelope mode, a number of active component carriers, a subcarrier spacing configuration per carrier, a control channel configuration per carrier, an aggregate bandwidth per carrier, a demodulation reference signal configuration per carrier, a channel state feedback configuration per carrier, a rank used for communication, a modulation and coding scheme used for communication, or a number of resource blocks per time period.

In certain aspects, receiving the signaling comprises receiving the signaling in a downlink control information.

In certain aspects, the signaling further indicates: a time period to operate according to the power level mode; and a second power level mode to operate according to after the time period.

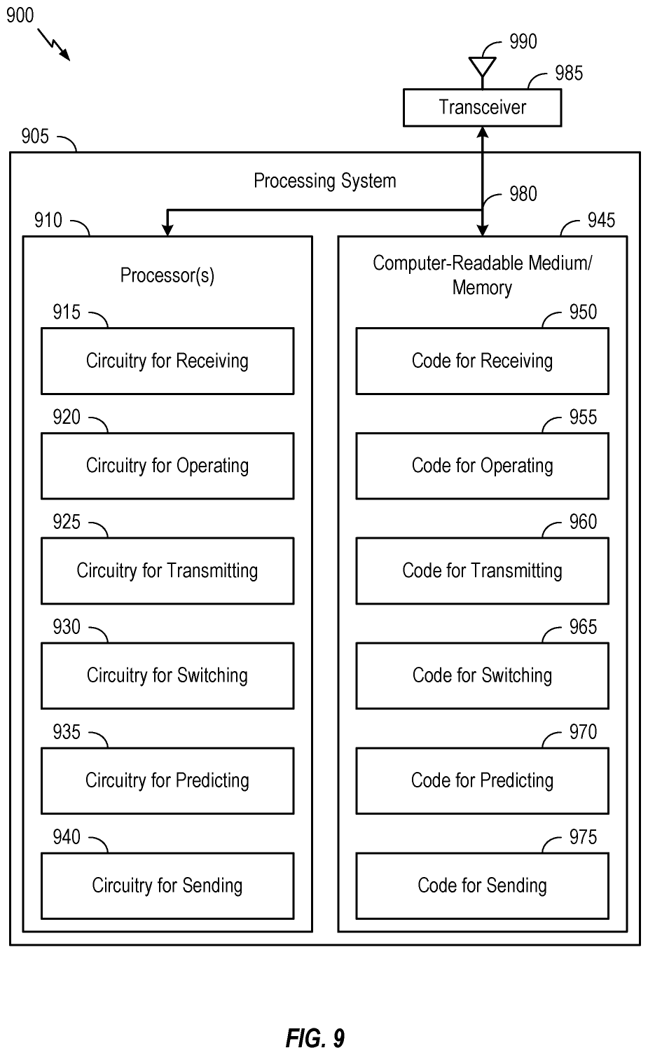

In certain aspects, method 700, or any aspect related to it, may be performed by an apparatus, such as communications device 900 of FIG. 9, which includes various components operable, configured, or adapted to perform the method 700. Communications device 900 is described below in further detail.

Note that FIG. 7 is just one example of a method, and other methods including fewer, additional, or alternative operations are possible consistent with this disclosure.

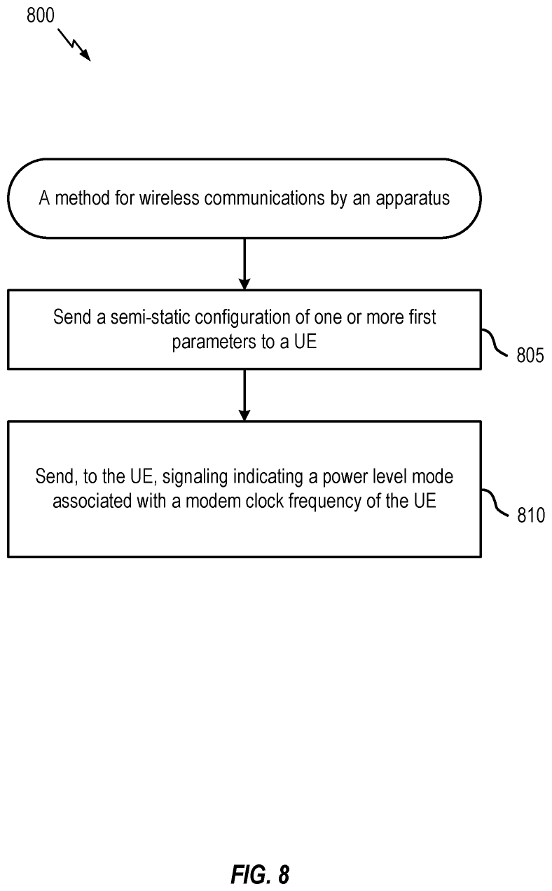

FIG. 8 shows a method 800 for wireless communications by an apparatus, such as BS 102 of FIGS. 1 and 3, or a disaggregated base station as discussed with respect to FIG. 2.

Method 800 begins at block 805 with sending a semi-static configuration of one or more first parameters to a UE. For example, a network entity may send semi-static configuration parameters (e.g., via RRC signaling), corresponding to a semi-static configuration, that configure a UE semi-statically such that the semi-static configuration parameters do not change often.

Method 800 then proceeds to block 810 with, (e.g., while the UE is configured according to the semi-static configuration) sending, to the UE, signaling indicating a power level mode associated with a modem clock frequency of the UE. For example, a plurality of power level modes may be defined, such as low power mode, mid power mode, and higher power mode. In certain aspects, the UE, such as part of capability reporting, such as during RRC configuration, is configured to send, to a network entity, a maximum capability of the UE for each of the plurality of power level modes. For example, in certain aspects, a maximum capability may indicate one or more maximum values for one or more parameters of the UE that the UE is capable of operating according to, such as one or more dynamic configuration parameters and/or one or more semi-static configuration paramaters, such as TB size, RB allocation, rank, a number of DMRS thresholds, and/or the like. In certain aspects, the UE operates according to the power level mode, such as for a time window, meaning it assumes the maximum configuration of parameters it reported for the power level mode, and sets the modem clock frequency based on the maximum configuration for the power level mode, such as a minimum clock frequency that supports the maximum configuration for the power level mode.

In certain aspects, the one or more first parameters comprise one or more of: an envelope mode, a number of active component carriers, a subcarrier spacing configuration per carrier, a control channel configuration per carrier, an aggregate bandwidth per carrier, a demodulation reference signal configuration per carrier, or a channel state feedback configuration per carrier.

In certain aspects, method 800 further includes sending, to the UE, a DCI configuring one or more CSI-RS resources, the DCI indicating a latency type.

In certain aspects, method 800 further includes receiving, from the UE, a maximum capability for one or more parameters for each of a plurality of power level modes including the power level mode.

In certain aspects, the one or more parameters comprise one or more of: an envelope mode, a number of active component carriers, a subcarrier spacing configuration per carrier, a control channel configuration per carrier, an aggregate bandwidth per carrier, a demodulation reference signal configuration per carrier, a channel state feedback configuration per carrier, a rank used for communication, a modulation and coding scheme used for communication, or a number of resource blocks per time period.

In certain aspects, block 810 includes sending the signaling in a downlink control information.

In certain aspects, the signaling further indicates: a time period to operate according to the power level mode; and a second power level mode to operate according to after the time period.

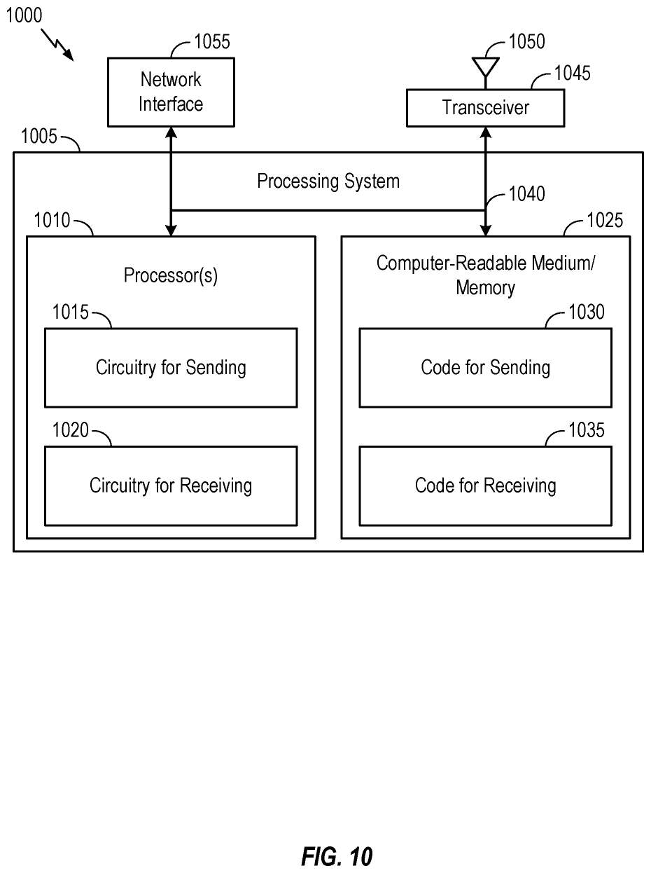

In certain aspects, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative operations are possible consistent with this disclosure.

### Example Communications Devices

FIG. 9 depicts aspects of an example communications device 900. In some aspects, communications device 900 is a user equipment, such as UE 104 described above with respect to FIGS. 1 and 3.

The communications device 900 includes a processing system 905 coupled to a transceiver 985 (e.g., a transmitter and/or a receiver). The transceiver 985 is configured to transmit and receive signals for the communications device 900 via an antenna 990, such as the various signals as described herein. The processing system 905 may be configured to perform processing functions for the communications device 900, including processing signals received and/or to be transmitted by the communications device 900.

The processing system 905 includes one or more processors 910. In various aspects, the one or more processors 910 may be representative of one or more of receive processor 358, transmit processor 364, TX MIMO processor 366, and/or controller/processor 380, as described with respect to FIG. 3. The one or more processors 910 are coupled to a computer-readable medium/memory 945 via a bus 980. In certain aspects, the computer-readable medium/memory 945 is configured to store instructions (e.g., computer-executable code) that when executed by the one or more processors 910, enable and cause the one or more processors 910 to perform the method 700 described with respect to FIG. 7, or any aspect related to it, including any operations described in relation to FIG. 7. Note that reference to a processor performing a function of communications device 900 may include one or more processors performing that function of communications device 900, such as in a distributed fashion.

In the depicted example, computer-readable medium/memory 945 stores code for receiving 950, code for operating 955, code for transmitting 960, code for switching 965, code for predicting 970, and code for sending 975. Processing of the code 950-975 may enable and cause the communications device 900 to perform the method 700 described with respect to FIG. 7, or any aspect related to it.

The one or more processors 910 include circuitry configured to implement (e.g., execute) the code stored in the computer-readable medium/memory 945, including circuitry for receiving 915, circuitry for operating 920, circuitry for transmitting 925, circuitry for switching 930, circuitry for predicting 935, and circuitry for sending 940. Processing with circuitry 915-940 may enable and cause the communications device 900 to perform the method 700 described with respect to FIG. 7, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 985 and/or antenna 990 of the communications device 900 in FIG. 9, and/or one or more processors 910 of the communications device 900 in FIG. 9. Means for communicating, receiving or obtaining may include the transceivers 354, antenna(s) 352, receive processor 358, AI processor 370, and/or controller/processor 380 of the UE 104 illustrated in FIG. 3, transceiver 985 and/or antenna 990 of the communications device 900 in FIG. 9, and/or one or more processors 910 of the communications device 900 in FIG. 9.

FIG. 10 depicts aspects of an example communications device 1000. In some aspects, communications device 1000 is a network entity, such as BS 102 of FIGS. 1 and 3, or a disaggregated base station as discussed with respect to FIG. 2.

The communications device 1000 includes a processing system 1005 coupled to a transceiver 1045 (e.g., a transmitter and/or a receiver) and/or a network interface 1055. The transceiver 1045 is configured to transmit and receive signals for the communications device 1000 via an antenna 1050, such as the various signals as described herein. The network interface 1055 is configured to obtain and send signals for the communications device 1000 via communications link(s), such as a backhaul link, midhaul link, and/or fronthaul link as described herein, such as with respect to FIG. 2. The processing system 1005 may be configured to perform processing functions for the communications device 1000, including processing signals received and/or to be transmitted by the communications device 1000.

The processing system 1005 includes one or more processors 1010. In various aspects, one or more processors 1010 may be representative of one or more of receive processor 338, transmit processor 320, TX MIMO processor 330, and/or controller/processor 340, as described with respect to FIG. 3. The one or more processors 1010 are coupled to a computer-readable medium/memory 1025 via a bus 1040. In certain aspects, the computer-readable medium/memory 1025 is configured to store instructions (e.g., computer-executable code) that when executed by the one or more processors 1010, enable and cause the one or more processors 1010 to perform the method 800 described with respect to FIG. 8, or any aspect related to it, including any operations described in relation to FIG. 8. Note that reference to a processor of communications device 1000 performing a function may include one or more processors of communications device 1000 performing that function, such as in a distributed fashion.

In the depicted example, the computer-readable medium/memory 1025 stores code for sending 1030 and code for receiving 1035. Processing of the code 1030 and 1035 may enable and cause the communications device 1000 to perform the method 800 described with respect to FIG. 8, or any aspect related to it.

The one or more processors 1010 include circuitry configured to implement (e.g., execute) the code stored in the computer-readable medium/memory 1025, including circuitry for sending 1015 and circuitry for receiving 1020. Processing with circuitry 1015 and 1020 may enable and cause the communications device 1000 to perform the method 800 described with respect to FIG. 8, or any aspect related to it.

More generally, means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 1045, antenna 1050, and/or network interface 1055 of the communications device 1000 in FIG. 10, and/or one or more processors 1010 of the communications device 1000 in FIG. 10. Means for communicating, receiving or obtaining may include the transceivers 332, antenna(s) 334, receive processor 338, AI processor 318, and/or controller/processor 340 of the BS 102 illustrated in FIG. 3, transceiver 1045, antenna 1050, and/or network interface 1055 of the communications device 1000 in FIG. 10, and/or one or more processors 1010 of the communications device 1000 in FIG. 10.

### Example Clauses

Implementation examples are described in the following numbered clauses:

Clause 1: A method for wireless communications by an apparatus comprising: receiving a semi-static configuration of one or more first parameters; and while the apparatus is configured according to the semi-static configuration: operating the modem clock at a first frequency; and operating the modem clock at a second frequency.

Clause 2: The method of Clause 1, wherein the one or more first parameters comprise one or more of: an envelope mode, a number of active component carriers, a subcarrier spacing configuration per carrier, a control channel configuration per carrier, an aggregate bandwidth per carrier, a demodulation reference signal configuration per carrier, or a channel state feedback configuration per carrier.

Clause 3: The method of any one of Clauses 1-2, wherein: operating the modem clock at the second frequency comprises, based on a first criteria, switching operation of the modem clock from the first frequency to the second frequency for a time period; and the first criteria comprises the apparatus being predicted to receive a retransmission of a data packet during the time period.

Clause 4: The method of Clause 3, further comprising: transmitting a negative acknowledgement, to a network entity, with respect to attempted reception of the data packet, wherein: the apparatus being predicted to receive the retransmission of data packet during the time period is based on transmission of the negative acknowledgement; and the time period begins at a time after transmission of the negative acknowledgement.

Clause 5: The method of Clause 4, wherein the time after transmission of the negative acknowledgement comprises one of: a first slot in time after transmission of the negative acknowledgement; a first slot in time after a first delay time after transmission of the negative acknowledgement, the first delay time equaling a round trip time between the apparatus and the network entity; or a first slot in time after a second delay time after transmission of the negative acknowledgement, the second delay time equaling a sum of a round trip time between the apparatus and the network entity and an additional delay time based on one or more delay parameters.

Clause 6: The method of Clause 5, wherein the one or more delay parameters comprise one or more of: a number of HARQ processes configured at the apparatus, a number of failed HARQ processes at the apparatus, a CDRX configuration of the apparatus, or a data scheduling pattern of the apparatus.

Clause 7: The method of Clause 3, further comprising: switching operation of the modem clock from the second frequency to the first frequency based on at least one of: elapse of one or more retransmission windows; or one or more retransmission buffers being empty.

Clause 8: The method of Clause 3, wherein the second frequency is based on one or more configuration parameters for transmission of the data packet.

Clause 9: The method of any one of Clauses 1-8, wherein: operating the modem clock at the second frequency comprises, based on a first criteria, switching operation of the modem clock from the first frequency to the second frequency for a time period; and the first criteria comprises the apparatus being scheduled to receive one or more CSI-RSs in one or more CSI-RS resources during the time period.

Clause 10: The method of Clause 9, wherein the time period begins at one of: a first slot in time of one or more slots including the one or more CSI-RS resources; or a first slot in time after reception of a downlink control information configuring the one or more CSI-RS resources.

Clause 11: The method of Clause 9, further comprising: receiving a DCI configuring the one or more CSI-RS resources, the DCI indicating a latency type, wherein the second frequency is based on the latency type.

Clause 12: The method of Clause 9, further comprising: switching operation of the modem clock from the second frequency to the first frequency based on transmission of a channel state feedback report based on the one or more CSI-RSs.

Clause 13: The method of any one of Clauses 1-12, wherein: operating the modem clock at the first frequency comprises operating the modem clock at the first frequency for a time period; and the first frequency is based on a predicted configuration of one or more second parameters associated with the time period, the one or more second parameters being different than the one or more first parameters.

Clause 14: The method of Clause 13, further comprising predicting the predicted configuration of the one or more second parameters based on one or more of: a network load; an uplink buffer status of the apparatus; a time division duplexing configuration of the apparatus; a frequency division duplex configuration of the apparatus; channel conditions between the apparatus and a network entity; or a MU-MIMO mode of operation during the time period.

Clause 15: The method of Clause 13, wherein the one or more second parameters comprise one or more of: whether the time period is configured for uplink or downlink communications; a rank used for communication during the time period; a modulation and coding scheme used for communication during the time period; or a number of resource blocks scheduled for the apparatus for communication during the time period.

Clause 16: The method of any one of Clauses 1-15, further comprising: receiving signaling indicating a power level mode from a network entity; wherein the first frequency is based on the power level mode.

Clause 17: The method of Clause 16, further comprising: sending, to the network entity, a maximum capability for one or more parameters for each of a plurality of power level modes including the power level mode.

Clause 18: The method of Clause 17, wherein the one or more parameters comprise one or more of: an envelope mode, a number of active component carriers, a subcarrier spacing configuration per carrier, a control channel configuration per carrier, an aggregate bandwidth per carrier, a demodulation reference signal configuration per carrier, a channel state feedback configuration per carrier, a rank used for communication, a modulation and coding scheme used for communication, or a number of resource blocks per time period.

Clause 19: The method of Clause 16, wherein receiving the signaling comprises receiving the signaling in a downlink control information.

Clause 20: The method of Clause 16, wherein the signaling further indicates: a time period to operate according to the power level mode; and a second power level mode to operate according to after the time period.

Clause 21: A method for wireless communications by an apparatus comprising: sending a semi-static configuration of one or more first parameters to a UE; and (e.g., while the UE is configured according to the semi-static configuration) sending, to the UE, signaling indicating a power level mode associated with a modem clock frequency of the UE.

Clause 22: The method of Clause 21, wherein the one or more first parameters comprise one or more of: an envelope mode, a number of active component carriers, a subcarrier spacing configuration per carrier, a control channel configuration per carrier, an aggregate bandwidth per carrier, a demodulation reference signal configuration per carrier, or a channel state feedback configuration per carrier.

Clause 23: The method of any one of Clauses 21-22, further comprising: sending, to the UE, a DCI configuring one or more CSI-RS resources, the DCI indicating a latency type.

Clause 24: The method of any one of Clauses 21-23, further comprising: receiving, from the UE, a maximum capability for one or more parameters for each of a plurality of power level modes including the power level mode.

Clause 25: The method of Clause 24, wherein the one or more parameters comprise one or more of: an envelope mode, a number of active component carriers, a subcarrier spacing configuration per carrier, a control channel configuration per carrier, an aggregate bandwidth per carrier, a demodulation reference signal configuration per carrier, a channel state feedback configuration per carrier, a rank used for communication, a modulation and coding scheme used for communication, or a number of resource blocks per time period.

Clause 26: The method of any one of Clauses 21-25, wherein sending the signaling comprises sending the signaling in a downlink control information.

Clause 27: The method of any one of Clauses 21-26, wherein the signaling further indicates: a time period to operate according to the power level mode; and a second power level mode to operate according to after the time period.

Clause 28: One or more apparatuses, comprising: one or more memories comprising executable instructions; and one or more processors configured to execute the executable instructions and cause the one or more apparatuses to perform a method in accordance with any one of Clauses 1-27.

Clause 29: One or more apparatuses, comprising: one or more memories; and one or more processors, coupled to the one or more memories, configured to cause the one or more apparatuses to perform a method in accordance with any one of Clauses 1-27.

Clause 30: One or more apparatuses, comprising: one or more memories; and one or more processors, coupled to the one or more memories, configured to perform a method in accordance with any one of Clauses 1-27.

Clause 31: One or more apparatuses, comprising means for performing a method in accordance with any one of Clauses 1-27.

Clause 32: One or more non-transitory computer-readable media comprising executable instructions that, when executed by one or more processors of one or more apparatuses, cause the one or more apparatuses to perform a method in accordance with any one of Clauses 1-27.

Clause 33: One or more computer program products embodied on one or more computer-readable storage media comprising code for performing a method in accordance with any one of Clauses 1-27.

Clause 34: A user equipment (UE), comprising: a processing system that includes processor circuitry and memory circuitry that stores code and is coupled with the processor circuitry, the processing system configured to cause the UE to perform a method in accordance with any one of Clauses 1-20.

Clause 35: A network entity, comprising: a processing system that includes processor circuitry and memory circuitry that stores code and is coupled with the processor circuitry, the processing system configured to cause the network entity to perform a method in accordance with any one of Clauses 21-27.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an Al processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus, comprising:
a modem clock; and
one or more processors, coupled to the modem clock, configured to:
receive a semi-static configuration of one or more first parameters; and
while the apparatus is configured according to the semi-static configuration:
operate the modem clock at a first frequency; and
operate the modem clock at a second frequency.

2. The apparatus of claim 1, wherein the one or more first parameters comprise one or more of: an envelope mode, a number of active component carriers, a subcarrier spacing configuration per carrier, a control channel configuration per carrier, an aggregate bandwidth per carrier, a demodulation reference signal configuration per carrier, or a channel state feedback configuration per carrier.

3. The apparatus of claim 1, wherein:
to operate the modem clock at the second frequency comprises, based on a first criteria, to switch operation of the modem clock from the first frequency to the second frequency for a time period; and
the first criteria comprises the apparatus being predicted to receive a retransmission of a data packet during the time period.

4. The apparatus of claim 3, wherein the one or more processors are configured to:
transmit a negative acknowledgement, to a network entity, with respect to attempted reception of the data packet, wherein:
the apparatus being predicted to receive the retransmission of data packet during the time period is based on transmission of the negative acknowledgement; and
the time period begins at a time after transmission of the negative acknowledgement.

5. The apparatus of claim 4, wherein the time after transmission of the negative acknowledgement comprises one of:
a first slot in time after transmission of the negative acknowledgement;
a first slot in time after a first delay time after transmission of the negative acknowledgement, the first delay time equaling a round trip time between the apparatus and the network entity; or
a first slot in time after a second delay time after transmission of the negative acknowledgement, the second delay time equaling a sum of a round trip time between the apparatus and the network entity and an additional delay time based on one or more delay parameters.

6. The apparatus of claim 5, wherein the one or more delay parameters comprise one or more of: a number of hybrid automatic repeat request (HARQ) processes configured at the apparatus, a number of failed HARQ processes at the apparatus, a connected mode discontinuous reception (CDRX) configuration of the apparatus, or a data scheduling pattern of the apparatus.

7. The apparatus of claim 3, wherein the one or more processors are configured to:
switch operation of the modem clock from the second frequency to the first frequency based on at least one of:
elapse of one or more retransmission windows; or
one or more retransmission buffers being empty.

8. The apparatus of claim 3, wherein the second frequency is based on one or more configuration parameters for transmission of the data packet.

9. The apparatus of claim 1, wherein:
to operate the modem clock at the second frequency comprises, based on a first criteria, to switch operation of the modem clock from the first frequency to the second frequency for a time period; and
the first criteria comprises the apparatus being scheduled to receive one or more channel state information (CSI) reference signals (CSI-RSs) in one or more CSI-RS resources during the time period.

10. The apparatus of claim 9, wherein the time period begins at one of:
a first slot in time of one or more slots including the one or more CSI-RS resources; or
a first slot in time after reception of a downlink control information configuring the one or more CSI-RS resources.

11. The apparatus of claim 9, wherein the one or more processors are configured to:
receive a downlink control information (DCI) configuring the one or more CSI-RS resources, the DCI indicating a latency type, wherein the second frequency is based on the latency type.

12. The apparatus of claim 9, wherein the one or more processors are configured to:
switch operation of the modem clock from the second frequency to the first frequency based on transmission of a channel state feedback report based on the one or more CSI-RSs.

13. The apparatus of claim 1, wherein:
to operate the modem clock at the first frequency comprises to operate the modem clock at the first frequency for a time period; and
the first frequency is based on a predicted configuration of one or more second parameters associated with the time period, the one or more second parameters being different than the one or more first parameters.

14. The apparatus of claim 13, wherein the one or more processors are configured to predict the predicted configuration of the one or more second parameters based on one or more of:
a network load;
an uplink buffer status of the apparatus;
a time division duplexing configuration of the apparatus;
a frequency division duplex configuration of the apparatus;
channel conditions between the apparatus and a network entity; or
a multi-user multiple-input and multiple-output (MU-MIMO) mode of operation during the time period.

15. The apparatus of claim 13, wherein the one or more second parameters comprise one or more of:
whether the time period is configured for uplink or downlink communications;
a rank used for communication during the time period;
a modulation and coding scheme used for communication during the time period; or
a number of resource blocks scheduled for the apparatus for communication during the time period.

16. The apparatus of claim 1, wherein:
the one or more processors are configured to receive signaling indicating a power level mode from a network entity; and
the first frequency is based on the power level mode.

17. The apparatus of claim 16, wherein the one or more processors are configured to:
send, to the network entity, a maximum capability for one or more parameters for each of a plurality of power level modes including the power level mode.

18. The apparatus of claim 16, wherein the signaling further indicates:
a time period to operate according to the power level mode; and
a second power level mode to operate according to after the time period.

19. A method for wireless communications by an apparatus comprising:
receiving a semi-static configuration of one or more first parameters; and
while the apparatus is configured according to the semi-static configuration:
operating a modem clock of the apparatus at a first frequency; and
operating the modem clock at a second frequency.

20. A non-transitory computer-readable medium comprising instructions, which when executed by one or more processors of an apparatus, cause the apparatus to perform operations comprising:
receiving a semi-static configuration of one or more first parameters; and
while the apparatus is configured according to the semi-static configuration:
operating a modem clock of the apparatus at a first frequency; and
operating the modem clock at a second frequency.
